(19) United States
(12) Patent Application Publication
(10) Pub. No.: US 2011/0173365 A1
(43) Pub. Date: Jul. 14, 2011

(54) ROTARY DISPLAY STAGE

(75) Inventor: Hong-Ming Wu, Sanchung City (TW)

(73) Assignee: JENN YAW J.Y. ENTERPRISES CO., LTD., Sanchung City (TW)

(21) Appl. No.: 12/978,821

(22) Filed: Dec. 27, 2010

(30) Foreign Application Priority Data
Jan. 8, 2010 (TW) 099200369

(51) Int. Cl. G06F 13/00; G06F 17/00

(52) U.S. Cl. 710/303; 700/94; 710/300

(57) ABSTRACT

A rotary display stage includes a display ground, an integrated circuit device, and a data transmission port. The display ground includes a base, and a rotary table arranged on the base. The base has a sound-effect switch structure and a track switch structure. The integrated circuit device is disposed inside the base, and includes an amplifier structure and a storage media. The data transmission port is arranged on the display ground and communicated with an exterior device optionally. The sound-effect switch structure, the track switch structure and the data transmission port electrically connect the integrated circuit device. Therefore, various audio data, except the tracks saved in the storage media previously, could optionally be played on via the data transmission port.

### BACKGROUND OF THE INVENTION

1. Field of the Invention

The present invention relates to a display ground, in particular, to a rotary display stage.

2. Description of Related Art

A conventional rotary display stage 10a, as illustrated in FIG. 1, is applied for displaying ingenious, precious or artistic-valued products 12a, such as watches, fine arts, artistic objects and so on. In addition, the conventional rotary display stage 10a further includes a light source 14a, which emits upwards from the bottom thereof, to strengthen the image.

Moreover, the conventional rotary display stage 10a further includes a sound-effect unit 16a to meet users' needs. However, the sound-effect unit 16a of the conventional rotary display 10a is saved with some tracks in advance for options. The rotary display stages for meeting high artistic performance and high musical requirement, such as 3C products, or religious arts, are usually predetermined with few tracks, these tracks not only dissatisfy the users but also failure to reach all users' needs.

### SUMMARY OF THE INVENTION

In view of the aforementioned issues, a rotary display stage for expanding the contents of media data flexibly without restrictions from the predetermined tracks is disclosed.

To achieve the above-mentioned objectives, the present invention provides a rotary display stage, which includes a display ground, an integrated circuit device, and a data transmission port. The display ground includes a base, and a rotary table arranged on the base. The base could be rectangular or annular, and the rotary table could be a rack or a stand. The base has a sound-effect switch structure and a track switch structure. The integrated circuit device is disposed inside the base, and includes an amplifier structure and a storage media. The data transmission port is arranged on the display ground and communicated with an exterior device optionally. The sound-effect switch structure, the track switch structure and the data transmission port electrically connect the integrated circuit device. Therefore, various audio data, except the tracks saved in the storage media previously, could optionally be played on via the data transmission port.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a perspective view of a conventional rotary display stage;

FIG. 2 is a perspective view of another conventional rotary display stage;

FIG. 3 is a perspective view in accordance with an embodiment of a rotary display stage according to the present invention;

FIG. 4 is a block diagram of the rotary display stage;

FIG. 5 is a perspective view with respect to another embodiment of the rotary display stage according to the present invention;

FIG. 6 is a perspective view with respect to another embodiment of the rotary display stage according to the present invention;

FIG. 7 is a perspective view with respect to another embodiment of the rotary display stage according to the present invention;

FIG. 8 is a perspective view with respect to an additional embodiment of the rotary display stage according to the present invention;

FIG. 9 is a perspective view with respect to a further embodiment of the rotary display stage according to the present invention; and

FIG. 10 is a perspective view with respect to a further embodiment of the rotary display stage according to the present invention.

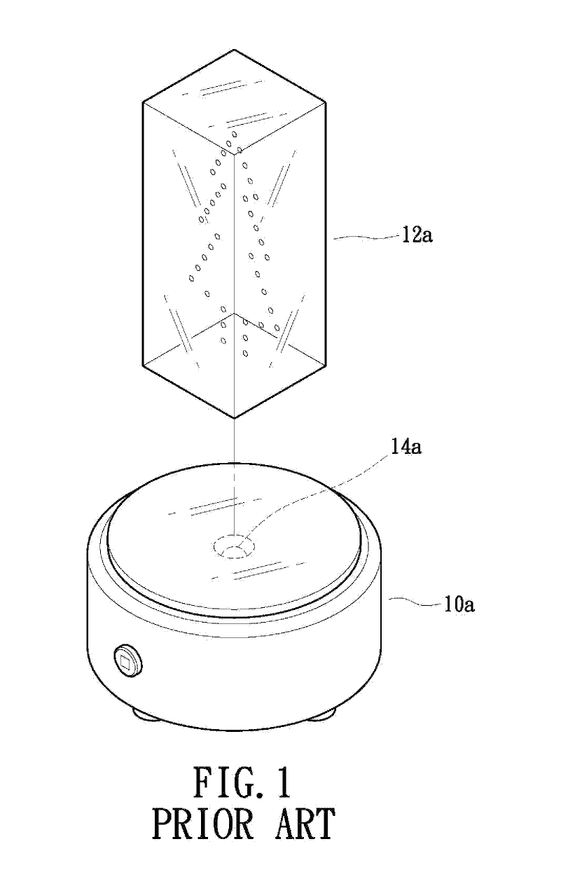

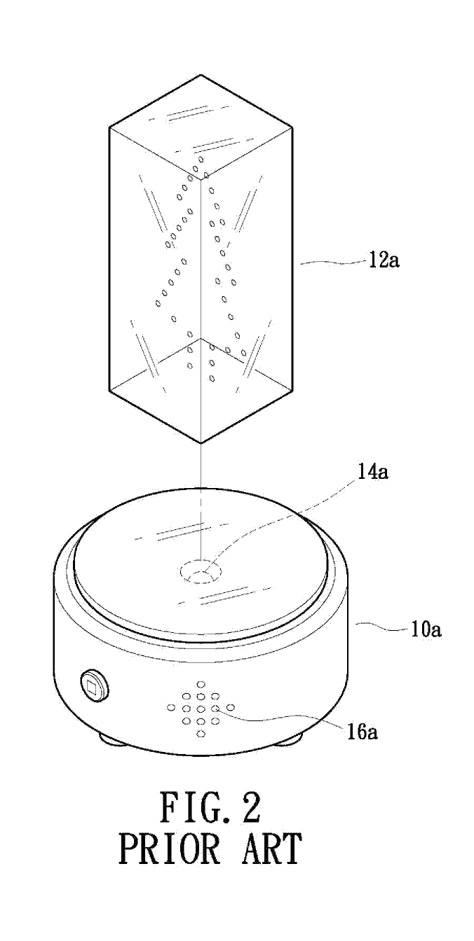

### DETAILED DESCRIPTION OF THE PREFERRED EMBODIMENTS

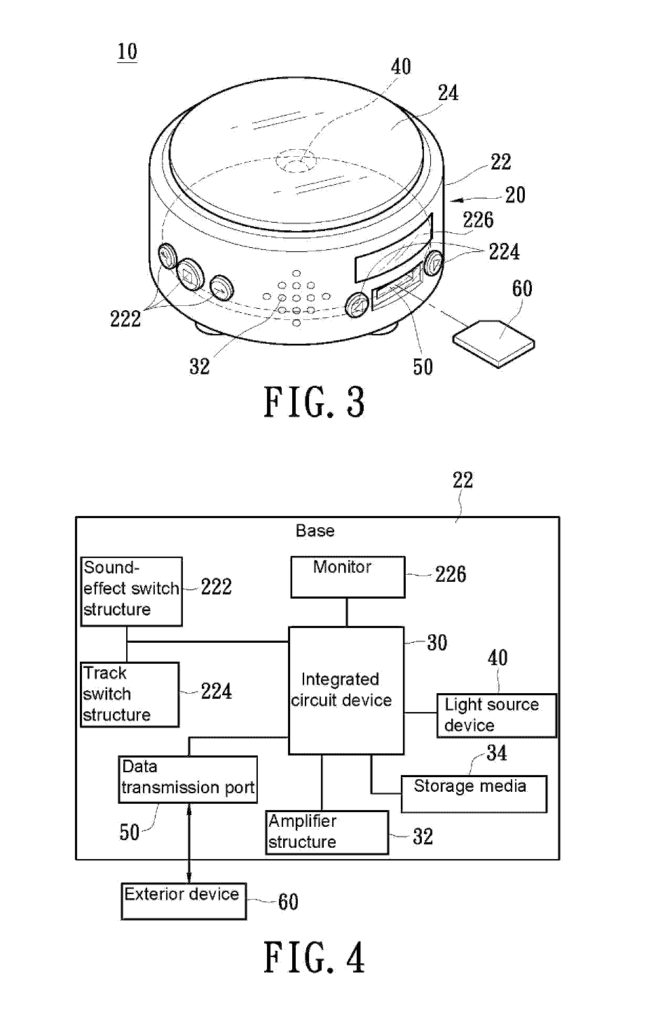

Referring now to FIGS. 3 and 4, in which a rotary display stage 10 in accordance with an embodiment according to the present invention is disclosed. The rotary display stage 10, which includes a display ground 20, an integrated circuit device 30, a light source device 40 and a data transmission port 50. The display ground 20 includes a base 22, and a rotary table 24 arranged on the base 22. The base 22 further includes a sound-effect switch structure 222, a track switch structure 224 and a monitor 226. The integrated circuit device 30 is disposed inside the base 22, and includes an amplifier structure 32 and a storage media 34. The data transmission port 50 is arranged on the display ground 20 and communicated with an exterior device 60 in an optional manner. The sound-effect switch structure 222 is used for controlling the sound volume.

The track switch structure 224 is used for controlling to switch various tracks.

The monitor 226 at least discloses the title of the track, the track numeral or the sound volume.

The storage media 34 has a plurality of tracks stored in advance.

The light source device 40 is arranged inside the base 22 and illuminates the rotary table 24.

Except the tracks saved in the storage media 34 previously, various audio data are optionally played on via the data transmission port 50. Flexible expansion of the contents of the tracks in accordance with the present invention is obtained, and further met broad exhibition and high-quality performance.

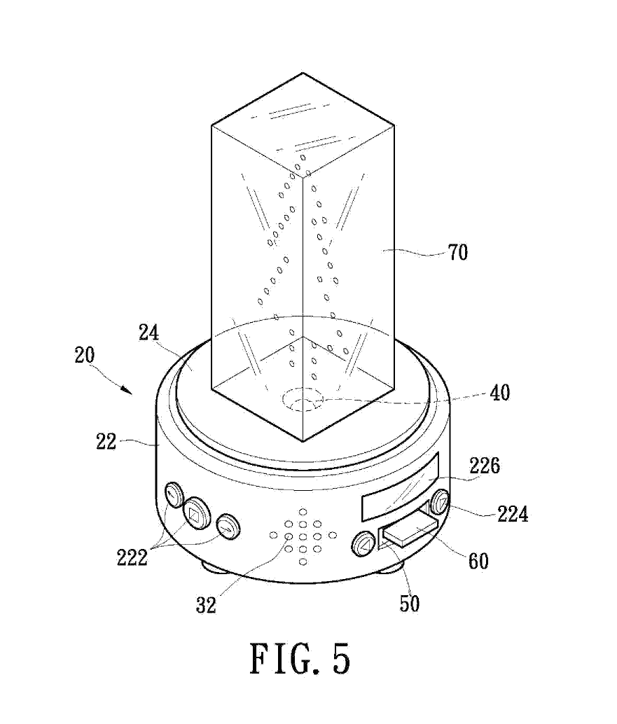

In accordance with FIG. 5, the rotary display stage 10 is applied with a rock crystal object 70, which stands on the rotary table 24. The rotary table 24 is driven by a driven motor (not shown) set in the base 22, and the driven motor electrically connects the integrated circuit device 30. The rotary stage 10 further includes a power source (not shown). The power source is a battery or a plug.

The light source device 40 offers kind of exhibition lighting for the crystal object 70, and it could be designed with LEDs. Usually, inside the rotary display stage 10, the storage media 34 is predetermined with few tracks, which hardly satisfy all the users. For example, some religious music for matching the crystal object 70 is not easy to obtain. The exterior device 60, a memory card, could be applied to the data transmission port 50 of the base 22. The track could be selected by adjusting the track switch structure 224. The track switch structure 224 includes at least two buttons, respectively representing forward selection and backward selection. The sound-effect switch structure 222 is further applied to adjust the volume of sound or to play or pause. The sound-effect switch structure 222 at least includes two sound-volume buttons, which respectively represents volume up and volume down, and a play button, which at least represents play, stop or pause. Through the amplifier structure 32, the selected track is broadcasted. Moreover, the media data with respect to the selected track could be read via the monitor 226.

The data transmission port 50 and the exterior device 60 (, the memory card,) are capable of accessing to each other for communication. They could at least meet CF, MS, SM, MMC, SD, or XD standard. The exterior device 60 is primarily saved quantities of media information, and it not only offers sufficient music but also benefits of being portable. The user could save the music, suits various requests, in the exterior device 60 as please. Therefore, the issue of lacking of the music in the storage media 34 of the base 22 could be redeemed.

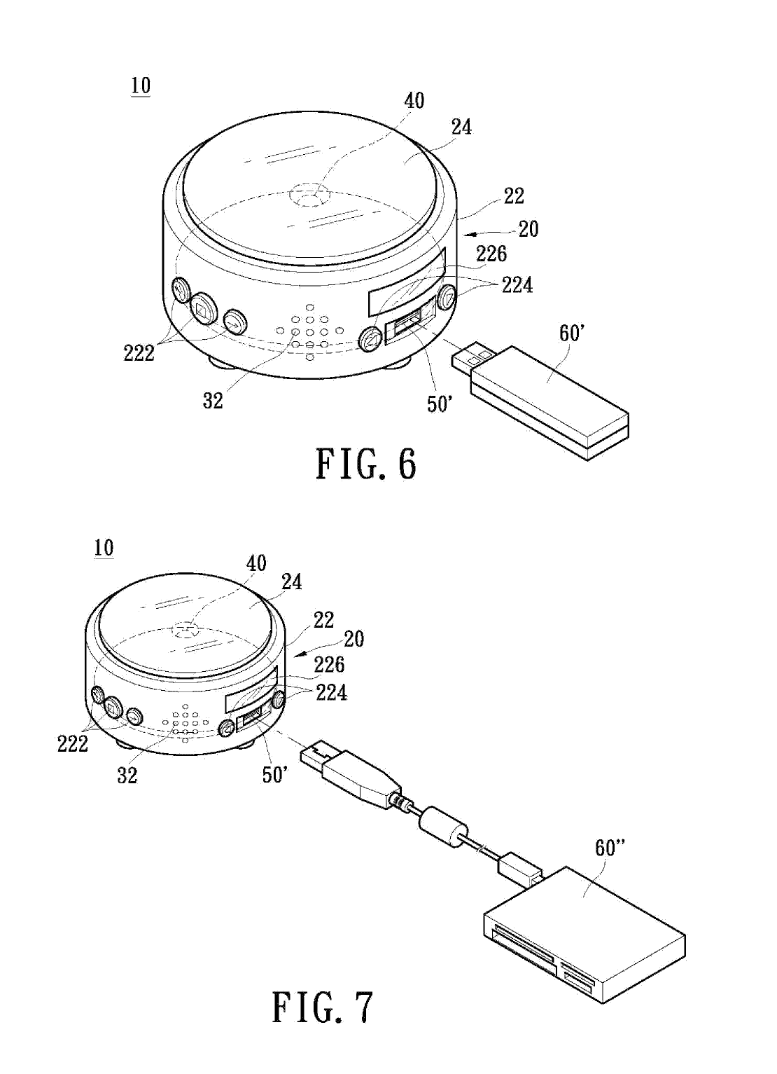

With respect to FIGS. 6 to 10, several embodiments of the rotary display stage in accordance with the present invention are disclosed. A data transmission port 50′ is a USB port, and the exterior device 60 could be a media storage device with USB interface, such as USB Thumb drive 60′ as in FIG. 6, a USB mini disc, or a multiple card reader 60″ as in FIG. 7. The card reader 60″ is at least adapted with a card of CF, MS, SM, MMC, SD or XD standard.

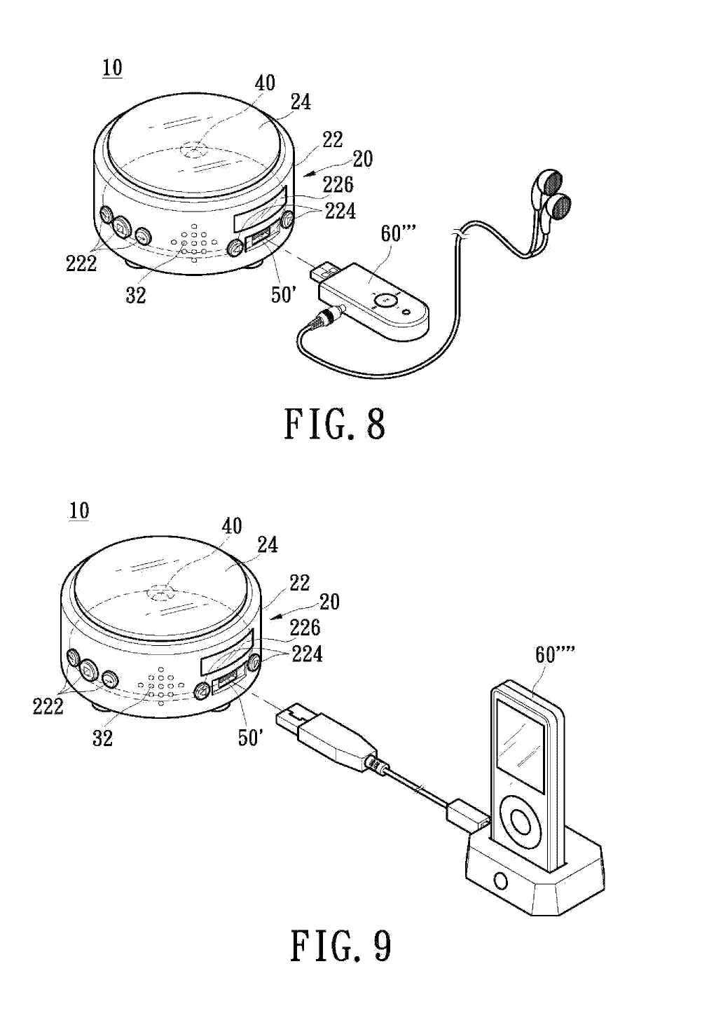

With respect to FIG. 8, the exterior device is a portable media player 60′″, which is able to be a portable MP3 player.

With respect to FIG. 9m the exterior device 60″″ could be a FireWire connector and Dock base for docking i-Pod products.

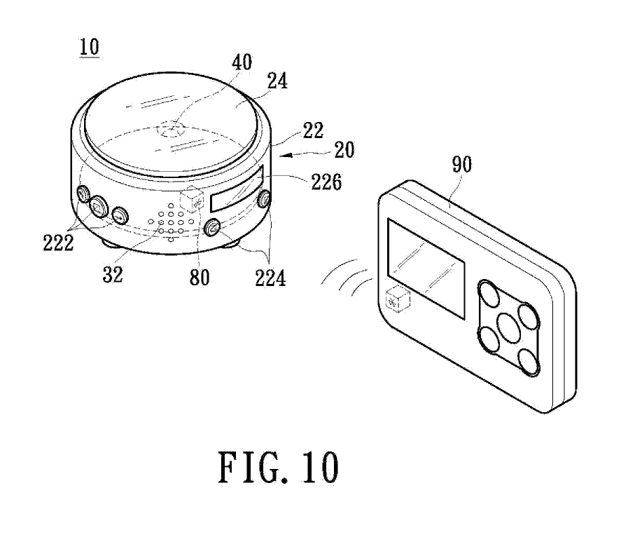

Moreover, the data transmission port is a wireless access port, which at least meets Bluetooth, infrared ray or IEEE802.11 of standards for wireless access, the exterior device is a storage media with a wireless access interface, which is able to communicate the data transmission port. With respect to FIG. 10, the data transmission port is a Bluetooth interface 80, and the exterior device is a Bluetooth MP3 player 90.

There is no restriction on media technology and substantial object of the exterior device, but the portability and the expansion thereof is benefited to augment the application of the rotary display stage. Except the predetermined music data stored in the storage media 34, various media information could be selected through the exterior device. Consequentially, the rotary display stage of flexible expansion media with high artistic performance and high musical requirement is disclosed.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A rotary display stage comprising:
a display ground including a base, and a rotary table arranged on the base;
wherein the base has:
a sound-effect switch structure controlling the sound volume; and
a track switch structure controlling to switch various tracks;
an integrated circuit device disposed inside the base, and including:
an amplifier structure;
a storage media having a plurality of tracks stored in advance; and
a data transmission port arranged on the display ground and communicated with an exterior device in an optional manner;
wherein the sound-effect switch structure, the track switch structure and the data transmission port electrically connect the integrated circuit device;
whereby various audio data, except the tracks saved in the storage media previously, are optionally played on via the data transmission port.

2. The rotary display stage according to claim 1, wherein the data transmission port is a USB port.

3. The rotary display stage according to claim 2, wherein the exterior device is a portable media player.

4. The rotary display stage according to claim 3, wherein the exterior device is a MP3 player.

5. The rotary display stage according to claim 2, wherein the exterior device is selected from a USB Thumb drive, a USB mini disc, or a flash memory card reader.

6. The rotary display stage according to claim 3, wherein the exterior device is selected from a USB Thumb drive, a USB mini disc, or a flash memory card reader

7. The rotary display stage according to claim 5, wherein the flash memory card reader is at least adapted with a card of CF, MS, SM, MMC, SD or XD standard.

8. The rotary display stage according to claim 2, wherein the exterior device includes a FireWire connector and Dock base for docking i-Pod products, and i-Pod products thereto.

9. The rotary display stage according to claim 1, wherein the data transmission port is a card-reading interface, the exterior device is a flash memory of CF, MS, SM, MMC, SD, or SD standard.

10. The rotary display stage according to claim 1, wherein the data transmission port is a wireless access port, which at least meets Bluetooth, infrared ray or

11. The rotary display stage according to claim 9, wherein the exterior device is a Bluetooth MP3 player.

12. The rotary display stage according to claim 1, further including a monitor, which at least discloses the title of the track, the track numeral or the sound volume.

13. The rotary display stage according to claim 1, further including a light source device arranged inside the base and electrically connecting the integrated circuit device; the light source device illuminates the rotary table.

14. The rotary display stage according to claim 1, wherein the rotary table is a rack or a stand.

15. The rotary display stage according to claim 1, wherein the base is rectangular or annular shaped-like.
